(19) United States
(12) Patent Application Publication
(10) Pub. No.: US 2020/0175734 A1
(43) Pub. Date: Jun. 4, 2020

(54) METHOD AND SYSTEM FOR GENERATING A DISPLAY COMPRISING A CURVE REPRESENTATIVE OF A CIRCULAR LIMIT ON A TERRESTRIAL SURFACE

(71) Applicant: Airbus Operations SAS, Toulouse (FR)

(72) Inventors: Sylvain RAYNAUD, TOULOUSE (FR); Esteban QUIROZ-HERNANDEZ, TOULOUSE (FR)

(21) Appl. No.: 16/696,369

(22) Filed: Nov. 26, 2019

(30) Foreign Application Priority Data
Nov. 30, 2018 (FR) 1872111

(51) Int. Cl. G06T 11/20; G01C 21/00; B64D 43/00

(52) U.S. Cl. CPC G06T 11/203; B64D 43/00; G01C 21/005

(57) ABSTRACT

A generating system comprises a module for determining coordinates of a first center and a first radius of a first circle, a module for determining a curve comprising points of a second circle having a second radius and a second center corresponding to an orthogonal projection of the first center onto a display plane and a sending module configured to send to a display module a signal representative of the curve to be displayed. The second radius corresponds to a distance between the second center and a curve point. The curve point corresponds to an orthogonal projection onto the display plane of a point of the first circle. The generating system displays on the display module a curve representative of a small circle with a sufficient precision without requiring substantial computational or display resources.

### CROSS-REFERENCES TO RELATED APPLICATIONS

This application claims the benefit of the French patent application No. 1872111 filed on Nov. 30, 2018, the entire disclosures of which are incorporated herein by way of reference.

### FIELD OF THE INVENTION

The present invention relates to a method and system for generating a display using a display module comprising at least one curve representative of at least one arc of a circle. The circle, generally called a “small circle,” corresponds to a circular limit on a terrestrial surface.

### BACKGROUND OF THE INVENTION

The navigation display of an aircraft displays data collected by navigation instruments. Generally, the navigation display must represent map data of a terrestrial surface on a planar surface that is tangent to the terrestrial surface at the center of the planar surface.

The map data required for navigation include circles or arcs centered on a point of the terrestrial surface and having a defined radius. These circles or these arcs are known as “small circles,” in contrast to “great circles” which correspond to circles the center of which corresponds to the center of the earth. The pilot of an aircraft uses the small circles, for example, to identify airports in flying range of the aircraft, or to identify parts of a geographical flight plan at a certain distance from a destination, from another airport, etc.

A small circle projected orthogonally onto the planar surface should appear as an ellipse. However, most navigation displays do not possess sufficient computational and/or display resources to represent an ellipse or an elliptical arc. In order to be able to represent a small circle, the navigation display uses the coordinates of the center of the small circle and its radius. The small circle is then represented by the navigation display by making an approximation by tracing a circle the center of which is the orthogonal projection of the center of the small circle onto the planar surface and the radius of which is equal to the radius of the small circle.

Up to now, this manner of displaying was satisfactory because the size of the small circles required was small enough for the approximation to be good. In the future, in certain cases, it will be necessary to achieve a representation of small circles of larger size, most particularly for extended-range twin-engined operations (ETOPS). Specifically, the approximation currently used could then lead to errors of about several hundred nautical miles (a nautical mile being about 1852 meters).

### SUMMARY OF THE INVENTION

An aim of the present invention is to mitigate these drawbacks by providing a method and system for generating using a display module a display comprising at least one curve representative of at least one arc of a small circle.

To this end, the invention relates to a method for generating a planar display using a display module, the planar display comprising at least one curve representative of at least one arc of a first circle corresponding to a circular limit on a terrestrial surface, the first circle having a first radius and a first center of coordinates located on the terrestrial surface, the planar display corresponding to a display zone located in a display plane.

According to the invention, the method comprises:
a first determining step, implemented by a first determination module, comprising determining the coordinates of the first center and the first radius;
a second determining step, implemented by a second determination module, comprising determining a curve comprising points of a second circle having a second radius and a second center, the second center corresponding to an orthogonal projection of the first center onto the display plane, the second radius corresponding to a distance between the second center and a curve point, the curve point corresponding to an orthogonal projection onto the display plane of a point of the first circle;
a sending step, implemented by a sending module, comprising sending to the display module a signal representative of the curve to be displayed.

Thus, by virtue of the invention, it is possible to display on a display module a curve representative of at least one arc of a small circle having a large size with a satisfactory precision without requiring substantial computational and/or display resources.

According to a first embodiment, the second determining step comprises:
a first determining substep, implemented by a first determination submodule, comprising determining the curve point, the curve point being located in the display zone or being likely to be located in the display zone after a preset time, the curve point corresponding to an orthogonal projection onto the display plane of a point of the first circle;
a second determining substep, implemented by a second determination submodule, comprising determining the second center corresponding to an orthogonal projection onto the display plane of the first center;
a first computing substep, implemented by a first computation submodule, comprising computing a radial distance on the display plane between the curve point and the second center;
a third determining substep, implemented by a third determination submodule, comprising determining the curve comprising the points of the second circle the center of which corresponds to the second center and the radius of which corresponds to the radial distance.

According to a second embodiment, the second determining step comprises:
a fourth determining substep, implemented by a fourth determination submodule, comprising determining at least two auxiliary curve points, the auxiliary curve points being located in the display zone or being likely to be located in the display zone after a preset time, each of the auxiliary curve points respectively corresponding to an orthogonal projection onto the display plane of a point of the first circle;
a fifth determining substep, implemented by a fifth determination submodule, comprising determining the curve point among the auxiliary curve points, the curve point corresponding to the auxiliary curve point closest to the display zone or the auxiliary curve point located in the display zone;
a sixth determining substep, implemented by a sixth determination submodule, comprising determining the second center corresponding to an orthogonal projection onto the display plane of the first center;
a second computing substep, implemented by a second computing submodule, comprising computing a radial distance on the display plane between the curve point and the second center;
a seventh determining substep, implemented by a seventh determination submodule, comprising determining the curve comprising the points of the second circle the center of which corresponds to the second center and the radius of which corresponds to the radial distance.

According to a third embodiment, the terrestrial surface being considered to be a spherical surface having a center called the center of the Earth and a radius called the radius of the Earth, the second determining step comprises:
an eighth determining substep, implemented by an eighth determination submodule, comprising determining coordinates of the center of the display zone;
a ninth determining substep, implemented by a ninth determination submodule, comprising determining a vector normal to an auxiliary plane, the auxiliary plane containing the center of the Earth, the first center of the first circle and the center of the display zone;
a tenth determining substep, implemented by a tenth determination submodule, comprising determining a cone angle having an apex at the center of the Earth and a base corresponding to the first circle;
an eleventh determining substep, implemented by an eleventh determination submodule, comprising determining the curve point, the curve point being determined by rotating the first center, about the normal vector determined in the ninth determining substep, in a direction pointing toward the center of the display zone, i.e., the center determined in the eighth determining substep;
a twelfth determining substep, implemented by a twelfth determination submodule, comprising determining the second center corresponding to an orthogonal projection onto the display plane of the first center;
a third computing substep, implemented by a third computation submodule, comprising computing a radial distance on the display plane between the curve point and the second center;
a thirteenth determining substep, implemented by a thirteenth determination submodule, comprising determining the curve comprising the points of the second circle the center of which corresponds to the second center and the radius of which corresponds to the radial distance.

In addition, the normal vector determined in the ninth determining substep is determined by computing a vector product of a unit vector having for direction a straight line passing through the center of the Earth and the first center of the first circle and of a unit vector having for direction a straight line passing through the center of the Earth and the center of the display zone.

Furthermore, the cone angle is determined by computing the ratio between the first radius and the radius of the Earth.

The invention also relates to a system for generating a planar display using a display module, the planar display comprising at least one curve representative of at least one arc of a first circle corresponding to a circular limit on a terrestrial surface, the first circle having a first radius and a first center of coordinates located on the terrestrial surface, the planar display corresponding to a display zone in a display plane.

According to the invention, the system comprises:
a first determination module configured to determine the coordinates of the first center and the first radius;
a second determination module configured to determine a curve comprising points of a second circle having a second radius and a second center, the second center corresponding to an orthogonal projection of the first center onto the display plane, the second radius corresponding to a distance between the second center and a curve point, the curve point corresponding to an orthogonal projection onto the display plane of a point of the first circle;
a sending module configured to send to the display module a signal representative of the curve to be displayed.

According to the first embodiment, the second determination module comprises:
a first determination submodule configured to determine the curve point, the curve point being located in the display zone or being likely to be located in the display zone after a preset time, the curve point corresponding to an orthogonal projection onto the display plane of a point of the first circle;
a second determination submodule configured to determine the second center corresponding to an orthogonal projection onto the display plane of the first center;
a first computation submodule configured to compute a radial distance on the display plane between the curve point and the second center;
a third determination submodule configured to determine the curve comprising the points of the second circle the center of which corresponds to the second center and the radius of which corresponds to the radial distance.

According to the second embodiment, the second determination module comprises:
a fourth determination submodule configured to determine at least two auxiliary curve points, the auxiliary curve points being located in the display zone or being likely to be located in the display zone after a preset time, each of the auxiliary curve points respectively corresponding to an orthogonal projection onto the display plane of a point of the first circle;
a fifth determination submodule configured to determine the curve point among the auxiliary curve points, the curve point corresponding to the auxiliary curve point closest to the display zone or the auxiliary curve point located in the display zone;
a sixth determination submodule configured to determine the second center corresponding to an orthogonal projection onto the display plane of the second center;
a second computation submodule configured to compute a radial distance on the display plane between the curve point and the second center;
a seventh determination submodule configured to determine the curve comprising the points of the second circle the center of which corresponds to the second center and the radius of which corresponds to the radial distance.

According to the third embodiment, the terrestrial surface being considered to be a spherical surface having a center called the center of the Earth and a radius called the radius of the Earth, the second determination module comprises:
an eighth determination submodule configured to determine coordinates of the center of the display zone;
a ninth determination submodule configured to determine a vector normal to an auxiliary plane, the auxiliary plane containing the center of the Earth, the first center of the first circle and the center of the display zone;
a tenth determination submodule configured to determine a cone angle having an apex at the center of the Earth and a base corresponding to the first circle;
an eleventh determination submodule configured to determine the curve point, the curve point being determined by rotating the first center, about the normal vector determined by the ninth determination submodule, in a direction pointing toward the center of the display zone, i.e., the center determined by the eighth determination submodule;
a twelfth determination submodule configured to determine the second center corresponding to an orthogonal projection onto the display plane of the first center;
a third computation submodule configured to compute a radial distance on the display plane between the curve point and the second center;
a thirteenth determination submodule configured to determine the curve comprising the points of the second circle the center of which corresponds to the second center and the radius of which corresponds to the radial distance.

The invention also relates to an aircraft, in particular a cargo plane, comprising a system for generating a planar display using a display module, such as that specified above.

### BRIEF DESCRIPTION OF THE DRAWINGS

The invention, with its features and advantages, will become more clearly apparent on reading the description given with reference to the appended drawings.

FIG. 1a schematically shows a first embodiment of the generating method.

FIG. 1b schematically shows a second embodiment of the generating method.

FIG. 1c schematically shows a third embodiment of the generating method.

FIG. 2 schematically shows the generating system.

FIG. 3a schematically shows a first embodiment of the second determination module of the generating system.

FIG. 3b schematically shows a second embodiment of the second determination module of the generating system.

FIG. 3c schematically shows a third embodiment of the second determination module of the generating system.

FIG. 4 shows an aircraft with the generating system located on-board.

FIG. 5 shows an example of a display generated by the generating system.

FIG. 6 shows a perspective view of a terrestrial surface on which are represented a great circle passing through the center of the Earth and a small circle.

FIG. 7 shows a perspective view of a terrestrial surface on which are represented a small circle and a display zone.

FIG. 8 shows a perspective view of a terrestrial surface on which are represented a small circle and a display zone and the projection, onto the display plane, of the small circle determined by prior-art systems and of the small circle determined by the generating system.

FIG. 9 shows one portion of the display plane, in which the display zone is located.

FIG. 10 shows a close-up view of the display zone of FIG. 9.

### DETAILED DESCRIPTION OF THE PREFERRED EMBODIMENTS

FIG. 2 shows the system 1 for generating a planar display using a display module DISPLAY 3. The system 1 is called the display system or generating system in the rest of the description. The generating system 1 is implemented by a flight management system FMS 8.

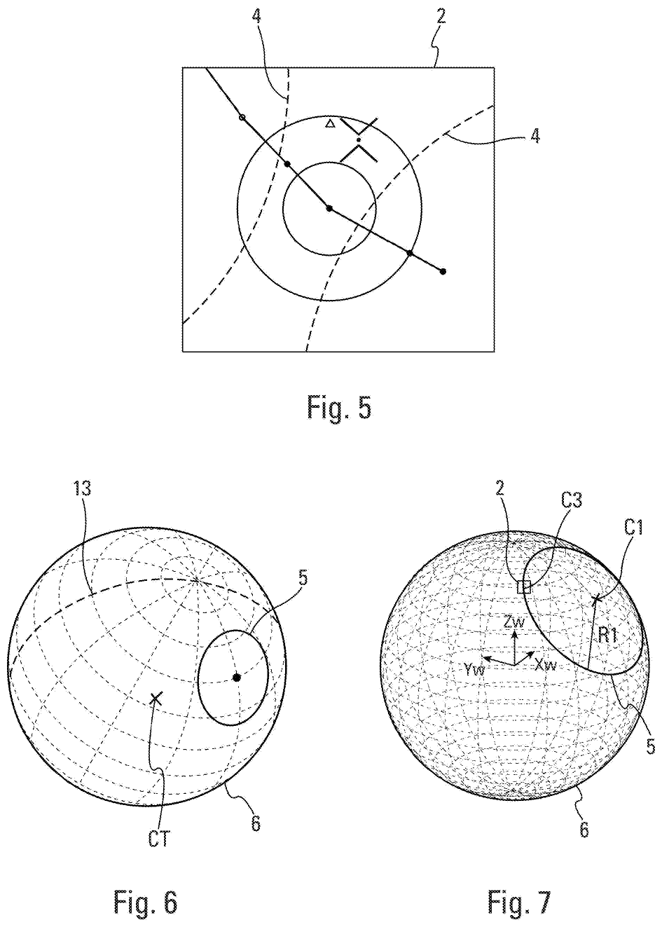

The planar display comprises at least one curve 4 representative of at least one arc of a circle 5 corresponding to a circular limit on a terrestrial surface 6. The circle 5 corresponds to a small circle. FIG. 5 shows an example of a display able to be generated by the display system 1. FIG. 6 shows a small circle 5 on the terrestrial surface 6 and a great circle 13.

The circle 5 has a radius R1 and a center C1 located on the terrestrial surface 6 (FIG. 7). The planar display corresponds to a display zone 2 contained in a display plane 11. The radius R1 is considered to correspond to a distance that is measured along the terrestrial surface 6, it for example corresponding to the distance on the ground travelled by the aircraft between the center C1 and a point of the circle 5.

The generating system 1, which is located on-board an aircraft AC (FIG. 4), comprises a determination module DET1 7 configured to determine the coordinates of the center C1 and the radius R1. Generally, the coordinates of the center C1 and the radius R1 are determined by a determination module at least on the basis of the position of the aircraft AC and on the basis of data delivered by a database located on the ground or an on-board database.

The generating system 1 furthermore comprises a determination module DET2 9 configured to determine a curve comprising points of a circle 10 having a radius R2 and a center C2. This center C2 corresponds to an orthogonal projection of the center C1 onto the display plane 11. The radius R2 corresponds to a distance between the center C2 and a curve point P. The curve point P corresponds to an orthogonal projection onto the display plane 11 of a point of the circle 5. In other words, the curve point P is projected perpendicular to the display plane 11.

The generating system 1 also comprises a sending module 12 configured to send to the display module 3 a signal representative of the curve to be displayed. The display module 3 may correspond to the display of a navigation display. The display zone 2 is entirely displayed by the display of the navigation display. The display module 3 computes the position of the center C2 on the display plane 11.

Thus, by virtue of the curve determined using the generating system 1, the display module 3 displays more precisely a flying-range limit (corresponding to the curve) of the aircraft AC with respect to a point that may correspond, for example, to an airport. The pilot of the aircraft AC may then use these data to confirm or modify a flight plan, for example.

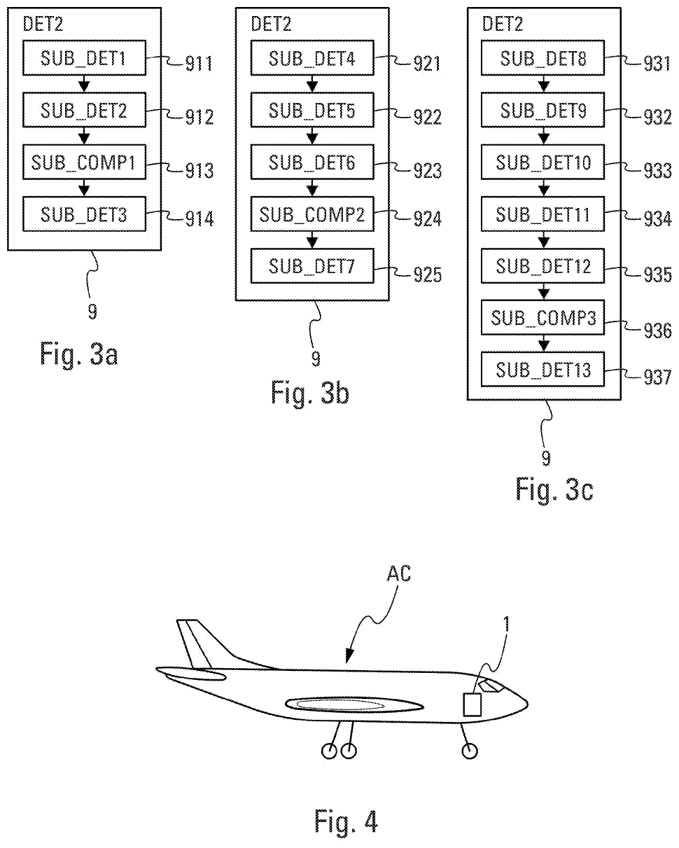

According to a first embodiment (FIG. 3a), the determination module 9 comprises a determination submodule SUB_DET1 911 configured to determine the curve point P. This curve point P corresponds to an orthogonal projection onto the display plane 11 of a point of the circle 5.

According to a first variant, this curve point P is located in the display zone 2. According to a second variant, the curve point P is likely to be located in the display zone 2 after a preset time. In this second variant, the curve point P is therefore in the vicinity of the display zone 2. It will be located, after a preset time, in the display zone 2 due to movement of the aircraft AC. These two variants may be combined together.

In this first embodiment, the determination module 9 furthermore comprises:
a determination submodule SUB_DET2 912 configured to determine the center C2 corresponding to an orthogonal projection onto the display plane 11 of the center C1,
a computation submodule SUB_COMP1 913 configured to compute a radial distance on the display plane 11 between the curve point P and the center C2 and
a determination submodule SUB_DET3 914 configured to determine the curve comprising the points of the circle 10 the center of which corresponds to the center C2 and the radius R2 of which corresponds to the radial distance.

According to a second embodiment (FIG. 3b), the determination module 9 comprises a determination submodule SUB_DET4 921 configured to determine at least two auxiliary curve points. Each of the auxiliary curve points respectively corresponds to an orthogonal projection onto the display plane 11 of a point of the circle 5.

According to a first variant, the auxiliary curve points are located in the display zone 2. According to a second variant, these auxiliary curve points are likely to be located in the display zone 2 after a preset time. In the same way as for the first embodiment, for this second variant, the auxiliary curve points are therefore in the vicinity of the display zone 2. They will be located, after a preset time, in the display zone 2 due to movement of the aircraft AC. These two variants may also be combined together.

The determination module 9 furthermore comprises a fifth determination submodule SUB_DET5 922 configured to determine the curve point P among the auxiliary curve points.

According to the second variant, the curve point P corresponds to the auxiliary curve point closest to the display zone 2 if no curve point is located in the display zone 2. Otherwise, the curve point P corresponds to an auxiliary curve point located in the display zone 2.

In this second embodiment, the determination module 9 furthermore comprises:
a determination submodule SUB_DET6 923 configured to determine the center C2 corresponding to an orthogonal projection onto the display plane 11 of the center C1,
a computation submodule SUB_COMP2 924 configured to compute a radial distance on the display plane 11 between the curve point P and the second center C2 and
a determination submodule SUB_DET7 925 configured to determine the curve comprising the points of the circle 10 the center of which corresponds to the center C2 and the radius R2 of which corresponds to the radial distance.

In a third embodiment (FIG. 3c), the terrestrial surface 6 is considered to be a spherical surface having a center called the center of the Earth CT and a radius called the radius of the Earth RT.

In this third embodiment, the determination module comprises:
a determination submodule SUB_DET8 931 configured to determine coordinates of the center C3 of the display zone 2
a determination submodule SUB_DET9 932 configured to determine a vector normal to an auxiliary plane, the auxiliary plane containing the center of the Earth CT, the center C1 of the circle 5 and the center C3 of the display zone 2,
a determination submodule SUB_DET10 933 configured to determine a cone angle having an apex at the center of the Earth CT and a base corresponding to the circle 5,
a determination submodule SUB_DET11 934 configured to determine the curve point P, the curve point P being determined by rotating the center C1, about the normal vector determined by the determination submodule 932, in a direction pointing toward the center C3 of the display zone 2, i.e., the center determined by the determination submodule 931,
a determination submodule SUB_DET12 935 configured to determine the center C2 corresponding to an orthogonal projection onto the display plane 11 of the center C1,
a computation submodule SUB_COMP3 936 configured to compute a radial distance on the display plane 11 between the curve point P and the center C2 and
a determination submodule SUB_DET13 937 configured to determine the curve comprising the points of the circle 10 the center of which corresponds to the center C2 and the radius R2 of which corresponds to the radial distance.

The normal vector determined by the determination module 932 is determined by computing a vector product of a unit vector having for direction a straight line passing through the center of the earth CT and the center C1 of the circle 5 and of a unit vector having for direction a straight line passing through the center of the Earth CT and the center C3 of the display zone 2.

The cone angle is determined by computing the ratio between the radius R1 and the radius of the Earth RT.

The curve point P determined in this third embodiment corresponds to the intersection closest to the center C3 of the display zone 2. The closest intersection corresponds to one of the intersections between, on the one hand, the great circle containing the center C1 and the center C3 of the display zone 2 and, on the other hand, the circle 5.

The generating system 1 also comprises a sending module SEND 12 configured to send to the display module 3 a signal representative of the curve 4 to be displayed.

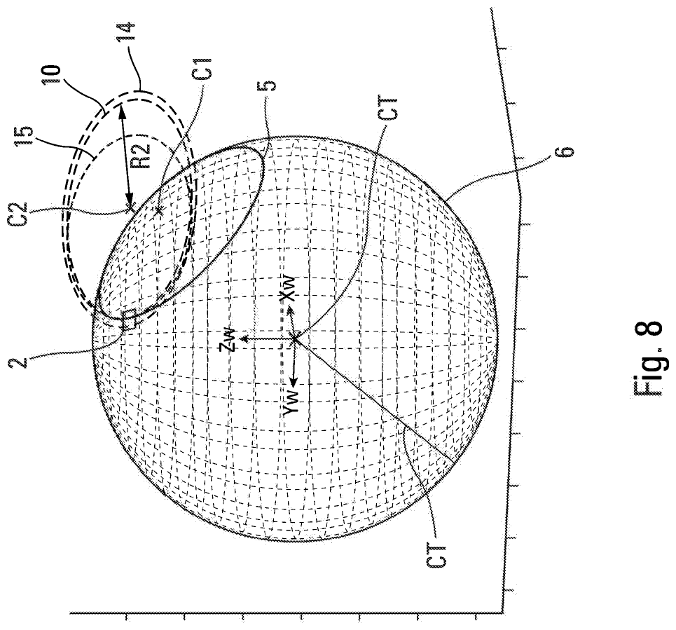

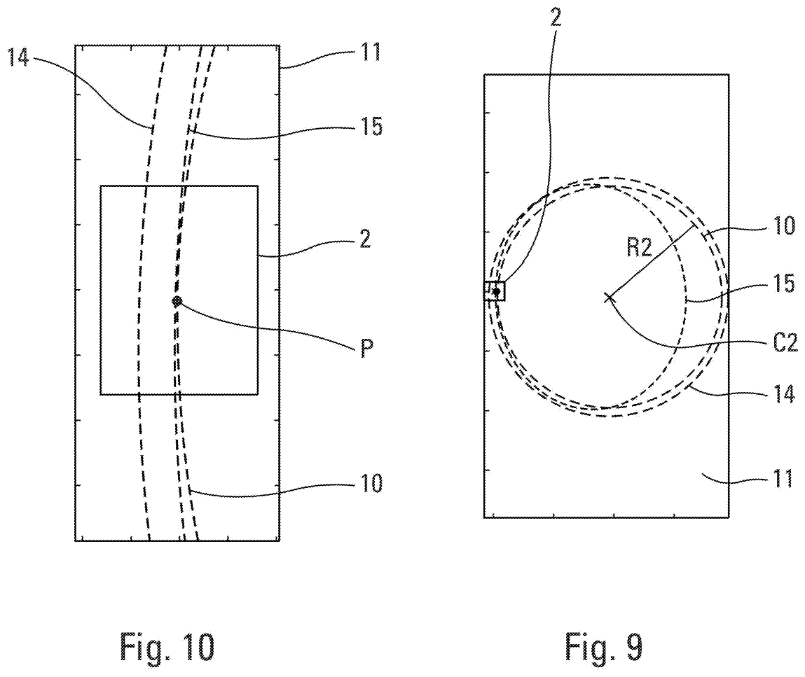

FIGS. 8 to 10 show, on the display plane 11, the circle 10 determined by the generating system 1 and a circle 14 determined by a prior-art system. These figures also show an ellipse 15 corresponding to the actual projection of the circle 5 onto the display plane 11. It may be seen that, in the display zone 2, the curve 4 determined by the generating system 1 is closer to the actual projection of the circle 5 than the curve of the circle 14. FIG. 10 shows that the circle 10 determined by the generating system 1 is tangent to the ellipse 15 at the curve point P in the display zone 2.

The invention also relates to a generating method that comprises:
a determining step E1, implemented by the determination module 7, comprising receiving the coordinates of the center C1 and the radius R1;
a determining step E2, implemented by the determination module 9, comprising determining a curve 4 comprising points of a circle 10 having a radius R2 and a center C2, the center C2 corresponding to an orthogonal projection of the center C1 onto the display plane 11, the radius R2 corresponding to a distance between the center C2 and a curve point P, the curve point P corresponding to an orthogonal projection onto the display plane 11 of a point of the circle 5;
a sending step E3, implemented by the sending module 12, comprising sending to the display module 3 a signal representative of the curve 4 to be displayed.

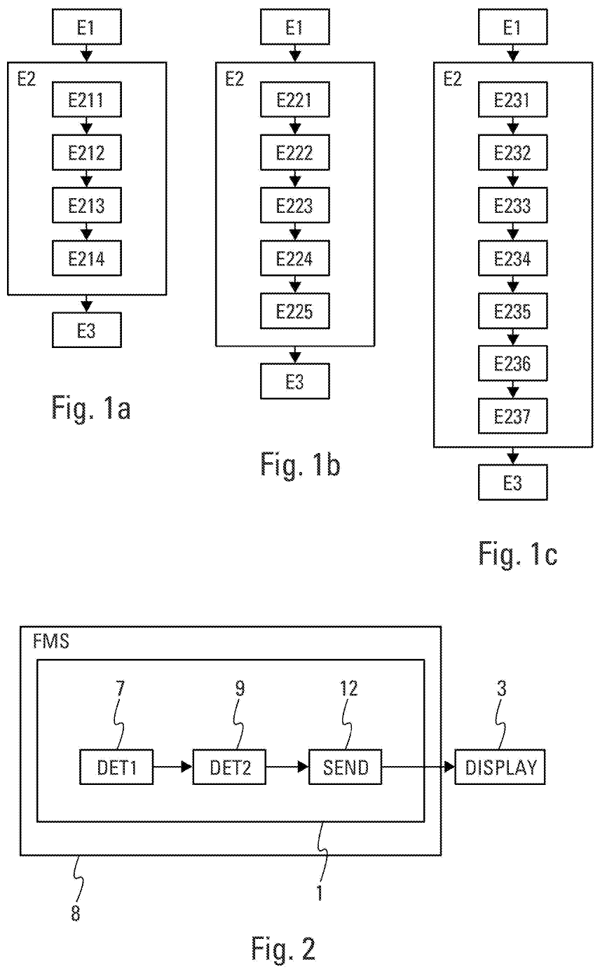

According to the first embodiment (FIG. 1a), the determining step E2 comprises:
a determining substep E211, implemented by the determination submodule 911, comprising determining the curve point P, the curve point P being located in the display zone 2 or being likely to be located in the display zone 2 after a preset time, the curve point P corresponding to an orthogonal projection onto the display plane 11 of a point of the circle 5;
a determining substep E212, implemented by the determination submodule 912, comprising determining the center C2 corresponding to an orthogonal projection onto the display plane 11 of the center C1;
a computing substep E213, implemented by the computation submodule 913, comprising computing a radial distance on the display plane 11 between the curve point P and the center C2;
a determining substep E214, implemented by the determination submodule 914, comprising determining the curve 4 comprising the points of the circle 10 the center of which corresponds to the center C2 and the radius R2 of which corresponds to the radial distance.

According to the second embodiment (FIG. 1b), the determining step E2 comprises:
a determining substep E221, implemented by the determination submodule 921, comprising determining at least two auxiliary curve points, the auxiliary curve points being located in the display zone 2 or being likely to be located in the display zone 2 after a preset time, each of the auxiliary curve points respectively corresponding to an orthogonal projection onto the display plane 11 of a point of the circle 5;
a determining substep E222, implemented by the determination submodule 922, comprising determining the curve point P among the auxiliary curve points, the curve point P corresponding to the auxiliary curve point closest to the display zone 2 or the auxiliary curve point located in the display zone 2;
a determining substep E223, implemented by the determination submodule 923, comprising determining the center C2 corresponding to an orthogonal projection onto the display plane 11 of the center C2;
a computing substep E224, implemented by the computing submodule 924, comprising computing a radial distance on the display plane 11 between the curve point P and the center C2;
a determining sub step E225, implemented by the determination submodule 925, comprising determining the curve 4 comprising the points of the circle 10 the center of which corresponds to the center C2 and the radius R2 of which corresponds to the radial distance.

According to the third embodiment (FIG. 1c), the determining step E2 comprises,
a determining substep E231, implemented by the determination submodule 931, comprising determining the coordinates of the center C3 of the display zone 2;
a determining substep E232, implemented by the determination submodule 932, comprising determining a vector normal to an auxiliary plane, the auxiliary plane containing the center of the Earth CT, the center C1 of the circle 5 and the center C3 of the display zone 2;
a determining substep E233, implemented by the determination submodule 933, comprising determining a cone angle having an apex at the center of the Earth CT and a base corresponding to the circle 5;
a determining sub step E234, implemented by the determination submodule 934, comprising determining the curve point P, the curve point P being determined by rotating the center C1, about the normal vector determined in the determining substep E232, in a direction pointing toward the center C3 of the display zone 2, i.e., the center determined in the determining substep E231;
a determining substep E235, implemented by the determination submodule 935, comprising determining the center C2 corresponding to an orthogonal projection onto the display plane 11 of the center C1;
a computing substep E236, implemented by a computation submodule 936, comprising computing a radial distance on the display plane 11 between the curve point P and the center C2;
a determining substep E237, implemented by a determination submodule 937, comprising determining the curve 4 comprising the points of the circle 10 the center of which corresponds to the center C2 and the radius R2 of which corresponds to the radial distance.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A method for generating a planar display using a display module, the planar display comprising at least one curve representative of at least one arc of a first circle corresponding to a circular limit on a terrestrial surface, the first circle having a first radius and a first center of coordinates located on the terrestrial surface, the planar display corresponding to a display zone located in a display plane, comprising:
a first determining step, implemented by a first determination module, comprising determining the coordinates of the first center and the first radius;
a second determining step, implemented by a second determination module, comprising determining a curve comprising points of a second circle having a second radius and a second center, the second center corresponding to an orthogonal projection of the first center onto the display plane, the second radius corresponding to a distance between the second center and a curve point, the curve point corresponding to an orthogonal projection onto the display plane of a point of the first circle;
a sending step, implemented by a sending module, comprising sending to the display module a signal representative of the curve to be displayed.

2. The method according to claim 1, wherein the second determining step comprises:
a first determining substep, implemented by a first determination submodule, comprising determining the curve point, the curve point being located in the display zone or being likely to be located in the display zone after a preset time, the curve point corresponding to an orthogonal projection onto the display plane of a point of the first circle;
a second determining substep, implemented by a second determination submodule, comprising determining the second center corresponding to an orthogonal projection onto the display plane of the first center;
a first computing substep, implemented by a first computation submodule, comprising computing a radial distance on the display plane between the curve point and the second center;
a third determining substep, implemented by a third determination submodule, comprising determining the curve comprising the points of the second circle, the center of which corresponds to the second center and the radius of which corresponds to the radial distance.

3. The method according to claim 1, wherein the second determining step comprises:
a fourth determining substep, implemented by a fourth determination submodule, comprising determining at least two auxiliary curve points, the auxiliary curve points being located in the display zone or being likely to be located in the display zone after a preset time, each of the auxiliary curve points respectively corresponding to an orthogonal projection onto the display plane of a point of the first circle;
a fifth determining substep, implemented by a fifth determination submodule, comprising determining the curve point among the auxiliary curve points, the curve point corresponding to the auxiliary curve point closest to the display zone or the auxiliary curve point located in the display zone;
a sixth determining substep, implemented by a sixth determination submodule, comprising determining the second center corresponding to an orthogonal projection onto the display plane of the first center;
a second computing substep, implemented by a second computing submodule, comprising computing a radial distance on the display plane between the curve point and the second center;
a seventh determining substep, implemented by a seventh determination submodule, comprising determining the curve comprising the points of the second circle, the center of which corresponds to the second center and the radius) of which corresponds to the radial distance.

4. A method according to claim 1, wherein, the terrestrial surface being considered to be a spherical surface having a center called the center of the Earth and a radius called the radius of the Earth, the second determining step comprises:
an eighth determining substep, implemented by an eighth determination submodule, comprising determining coordinates of the center of the display zone;
a ninth determining substep, implemented by a ninth determination submodule, comprising determining a vector normal to an auxiliary plane, the auxiliary plane containing the center of the Earth, the first center of the first circle and the center of the display zone;
a tenth determining substep, implemented by a tenth determination submodule, comprising determining a cone angle having an apex at the center of the Earth and a base corresponding to the first circle;
an eleventh determining substep, implemented by an eleventh determination submodule, comprising determining the curve point, the curve point being determined by rotating the first center, about the normal vector determined in the ninth determining substep, in a direction pointing toward the center of the display zone, i.e., the center determined in the eighth determining substep;
a twelfth determining substep, implemented by a twelfth determination submodule, comprising determining the second center corresponding to an orthogonal projection onto the display plane of the first center;
a third computing substep, implemented by a third computation submodule, comprising computing a radial distance on the display plane between the curve point and the second center;
a thirteenth determining substep, implemented by a thirteenth determination submodule, comprising determining the curve comprising the points of the second circle the center of which corresponds to the second center and the radius of which corresponds to the radial distance.

5. The method according to claim 4, wherein the normal vector determined in the ninth determining substep is determined by computing a vector product of a unit vector having for direction a straight line passing through the center of the Earth and the first center of the first circle and of a unit vector having for direction a straight line passing through the center of the Earth and the center of the display zone.

6. The method according to claim 4, wherein the cone angle is determined by computing a ratio between the first radius and the radius of the Earth.

7. A system for generating a planar display using a display module, the planar display comprising at least one curve representative of at least one arc of a first circle corresponding to a circular limit on a terrestrial surface, the first circle having a first radius and a first center of coordinates located on the terrestrial surface, the planar display corresponding to a display zone in a display plane, comprising:
a first determination module configured to determine the coordinates of the first center and the first radius;
a second determination module configured to determine a curve comprising points of a second circle having a second radius and a second center, the second center corresponding to an orthogonal projection of the first center onto the display plane, the second radius corresponding to a distance between the second center and a curve point, the curve point corresponding to an orthogonal projection onto the display plane of a point of the first circle;
a sending module configured to send to the display module a signal representative of the curve to be displayed.

8. The system according to claim 7, wherein the second determination module comprises:
a first determination submodule configured to determine the curve point, the curve point being located in the display zone or being likely to be located in the display zone after a preset time, the curve point corresponding to an orthogonal projection onto the display plane of a point of the first circle;
a second determination submodule configured to determine the second center corresponding to an orthogonal projection onto the display plane of the first center;
a first computation submodule configured to compute a radial distance on the display plane between the curve point and the second center;
a third determination submodule configured to determine the curve comprising the points of the second circle, the center of which corresponds to the second center and the radius of which corresponds to the radial distance.

9. The system according to claim 7, wherein the second determination module comprises:
a fourth determination submodule configured to determine at least two auxiliary curve points, the auxiliary curve points being located in the display zone or being likely to be located in the display zone after a preset time, each of the auxiliary curve points respectively corresponding to an orthogonal projection onto the display plane of a point of the first circle;
a fifth determination submodule configured to determine the curve point among the auxiliary curve points, the curve point corresponding to the auxiliary curve point closest to the display zone or the auxiliary curve point located in the display zone;
a sixth determination submodule configured to determine the second center corresponding to an orthogonal projection onto the display plane of the second center;
a second computation submodule configured to compute a radial distance on the display plane between the curve point and the second center;
a seventh determination submodule configured to determine the curve comprising the points of the second circle, the center of which corresponds to the second center and the radius of which corresponds to the radial distance.

10. The system according to claim 7, wherein, the terrestrial surface being considered to be a spherical surface having a center called the center of the Earth and a radius called the radius of the Earth, the second determination module comprises:
an eighth determination submodule configured to determine coordinates of the center of the display zone;
a ninth determination submodule configured to determine a vector normal to an auxiliary plane, the auxiliary plane containing the center of the Earth, the first center of the first circle and the center of the display zone;
a tenth determination submodule configured to determine a cone angle having an apex at the center of the Earth and a base corresponding to the first circle;
an eleventh determination submodule configured to determine the curve point, the curve point being determined by rotating the first center, about the normal vector determined by the ninth determination submodule, in a direction pointing toward the center of the display zone, i.e., the center determined by the eighth determination submodule;
a twelfth determination submodule configured to determine the second center corresponding to an orthogonal projection onto the display plane of the first center;
a third computation submodule configured to compute a radial distance on the display plane between the curve point and the second center;
a thirteenth determination submodule configured to determine the curve comprising the points of the second circle, the center of which corresponds to the second center and the radius of which corresponds to the radial distance.

11. An aircraft comprising a system for generating a planar display using the display module of claim 7.
